(19) United States
(12) Patent Application Publication
(10) Pub. No.: US 2004/0125618 A1
(43) Pub. Date: Jul. 1, 2004

(54) Multiple energy-source power converter system

(76) Inventors: Michael De Rooij, Clifton Park, NY (US); Robert Steigerwald, Burnt Hills, NY (US)

Correspondence Address: Patrick S. Yoder, Fletcher, Yoder & Van Someren, P.O. Box 692289, Houston, TX, 77269-2289, US

(21) Appl. No.: 10/329,906

(22) Filed: Dec. 26, 2002

(51) Int. Cl. H02M 3/335

(52) U.S. Cl. 363/17

(57) ABSTRACT

A flexible integrated power converter system that connects various types of electrical power sources together and supplies a defined type of electrical energy to a load, such as a standard household mains voltage supply, is provided. Each of the electrical power sources is electrically isolated from the load, as well as each other. A respective input converter is coupled to each power source. Each input converter may include a small high-frequency transformer driven by an efficient soft-switched dc-dc converter. The voltages produced by each of the input converters are combined in parallel and delivered to a single output inverter. The output inverter converts the combined voltages to an ac voltage that may be delivered to a load.

### BACKGROUND OF THE INVENTION

Environmental concerns and the development of alternative sources of electrical energy suitable for supplying a household or commercial site have driven the desire for systems that can process the various forms of electrical energy into a standard and usable form. There are many alternative power sources that may be implemented to provide households and commercial sites with power, such as photovoltaic systems, batteries, fuel cells, wind turbines, fuel-based generators and ultra capacitors, for example. As can be appreciated, one or more energy sources may be implemented at a single site to satisfy the energy needs of the site, and each of the independent energy sources may supply energy at different voltage levels. Accordingly, hybrid power systems having two or more different sources and producing energy at various voltage levels may be implemented at a single site, such as a household, office, warehouse or commercial site.

Generally speaking, in conventional multi-source systems, an independent converter system is implemented for each type of power source such that the energy provided from each alternative source can be converted to a common voltage level that may be used to supply power to a mains supply or load. Each separate converter system may independently deliver power into a mains supply or load for use through standard electrical sockets, for instance. Disadvantageously, conventional multi-source power conversion systems may be inefficient, because they are not generally optimized for multiple energy sources, which may lead to poor utilization of excess available energy. Further, conventional conversion systems may have a relatively short mean-time-to-failure (e.g., less than 10 years). Still further, conventional multi-energy-source power conversion systems may not provide for electrical grounding of the system in a safe and effective manner.

### BRIEF DESCRIPTION OF THE INVENTION

In accordance with one aspect of the present techniques, there is provided a power conversion system comprising: a first input converter configured to receive a first input voltage from a first power source and to produce a first converted input voltage; a second input converter configured to receive a second input voltage from a second power source and to produce a second converted input voltage; a combining circuit configured to receive each of the first converted input voltage and the second converted input voltage and to combine the first converted input voltage and the second converted input voltage to produce a common converted voltage; and an output inverter configured to receive the common converted voltage and to produce an ac output voltage.

In accordance with another aspect of the present techniques, there is provided a power conversion system comprising: a first conversion block comprising: a first input converter configured to convert a first dc power source voltage from a first voltage level to a second voltage level; a dc link electrically coupled to the input converter and configured to receive the first dc power source voltage having the second voltage level from the first input converter and to include the first dc power source voltage with a second dc power source voltage having the second voltage level to produce a common dc power source voltage; and an output inverter electrically coupled to the dc link and configured to convert the common dc power source voltage to an ac power source voltage; and a second conversion block electrically coupled to the dc link of the first conversion block and configured to convert the second dc power source voltage from a third voltage level to the second voltage level and configured to output the second dc power source voltage to the dc link for inclusion with the first dc power source voltage.

In accordance with a further aspect of the present techniques, there is provided an integrated power source comprising: a plurality of electrical power sources each configured to produce a respective dc voltage; a plurality of input converters, wherein each of the plurality of input converters is electrically coupled to a respective one of the plurality of electrical power sources, and wherein each of the plurality of input converters is configured to receive a respective dc voltage and to convert the respective dc voltage to a common dc voltage level and to produce a respective output having the common voltage level; a linking element coupled to each of the plurality of input converters and configured to combine each of the respective outputs to provide a combined dc voltage having the common voltage level; and an output inverter coupled to the linking element and configured to receive the combined dc voltage and to convert the combined dc voltage to an ac output voltage.

In accordance with still another aspect of the present techniques, there is provided a method of converting power from multiple sources comprising: receiving a first voltage at a first input converter, the first voltage having a first voltage level; receiving a second voltage at a second input converter, the second voltage having a second voltage level; converting the first voltage level of the first voltage to a third voltage level; converting the second voltage level of the second voltage to the third voltage level; combining the first voltage having the third voltage level and the second voltage having the third voltage level to produce a third voltage having the third voltage level; and converting the third voltage to an ac voltage having a fourth voltage level.

### BRIEF DESCRIPTION OF THE DRAWINGS

Advantages and features of the invention may become apparent upon reading the following detailed description and upon reference to the drawings in which:

FIG. 1 is a block diagram illustrating a multiple source converter system in accordance with embodiments of the present techniques;

FIG. 2 is an exemplary embodiment of an input converter for use in the multiple source converter system of FIG. 1;

FIG. 3 is an exemplary embodiment of an output inverter for use in the multiple source converter system of FIG. 1; and

FIG. 4 is an alternate exemplary embodiment of an output inverter for use in the multiple source converter system of FIG. 1.

### DETAILED DESCRIPTION OF SPECIFIC EMBODIMENTS

Generally speaking, the present techniques provide a flexible integrated power converter system that connects various types of electrical power sources together and supplies a defined type of electrical energy to a load such as a standard household mains voltage supply. The electrical sources may include photovoltaic arrays, wind generators, batteries, engine-driven generators, fuel cells, or ultra capacitors, for instance, and may be provided in any combination. All of the sources may be electrically isolated from the output mains, as well as each other, using a small high-frequency transformer driven by an efficient soft-switched dc-dc converter, for example. This allows safe grounding schemes to be implemented for any type of source and according to various local safety codes. The integrated power converter system may also be used to supply electrical energy back to the mains network in the event that excess energy is available. The integrated power converter system may be implemented for medium power ranges such as those used for a household or commercial site, for example. The converter system may also be configured to supply energy to the load in the event of a mains failure.

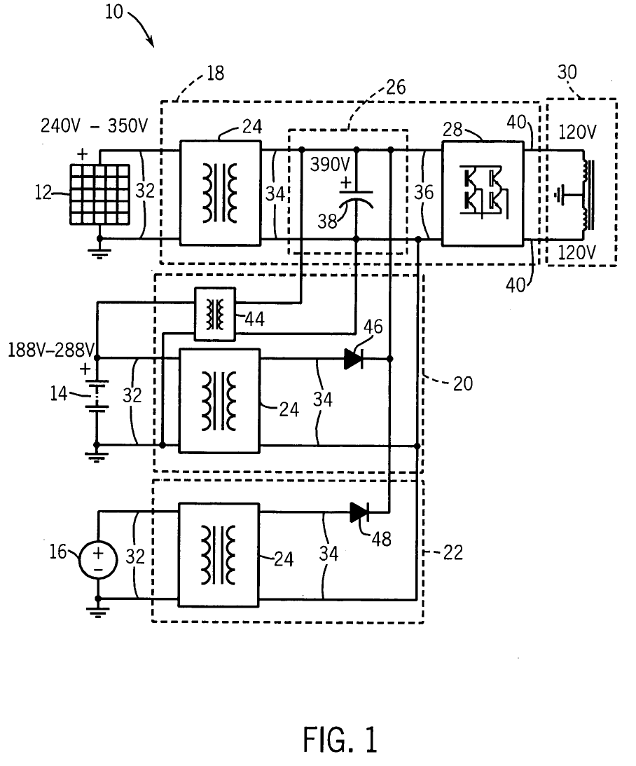

Referring specifically to FIG. 1, a block diagram (having partial schematic representations) of a multiple source converter system 10 in accordance with one embodiment of the present techniques is illustrated. The present exemplary embodiment of the system 10 generally includes a main power source, here a photovoltaic array 12, a battery source 14 and an alternative source 16, such as a fuel cell or wind turbine, for instance. While the exemplary main energy source comprises a photovoltaic array 12, other sources may be used as the main power source, as can be appreciated by those skilled in the art. Further, while the system 10 illustrates a battery source 14 and a single alternative source 16, is should be understood that the system 10 may comprise any combination of two or more power sources, such as photovoltaic arrays, wind generators, batteries, engine-driven generators, fuel cells, or ultra capacitors, for instance, and that the battery source 14 and alternative source 16 are merely provided by way of example.

The exemplary multiple source converter system 10 comprises a photovoltaic converter 18 which receives the output voltage from the photovoltaic array 12. The photovoltaic array 12 may provide outputs having voltages in the range of 240-350 volts, for example. Similarly, the system 10 comprises a battery converter 20 which receives the output voltages from the battery source 14. The battery source may provide outputs having voltages in the range of 188-288 volts, for example. The system 10 also comprises an alternative power source converter 22 which receives the output voltages from the alternative power source 16. The output voltage of the alternate power source 16 may vary depending on the specific source implemented, as can be appreciated by those skilled in the art. Advantageously, each of the converters 18, 20 and 22 of the system 10 is galvanically isolated such that grounding may be implemented at any point in the system, in accordance with customer specifications or local guidelines.

Each converter 18, 20 and 22 includes a dc-to-dc input converter 24. To reduce the design variations throughout the system 10 and thereby reduce the overall cost of the system 10, the same type of input converter 24 may be implemented in each of the converters 18, 20 and 22. Alternatively, different types of input converters may be used in each converter 18, 20 and 22, as can be appreciated by those skilled in the art. Further, because the photovoltaic source 12 is the main source in the present system 10, the photovoltaic source 12 comprises a regulated dc-link 26 and an output inverter 28, as will be described further below. The output inverter 28 may be coupled directly to a load 30, such as a mains power supply in a household, for instance.

The input converter 24 interfaces a respective source (e.g., photovoltaic array 12, battery source 14 or alternative source 16) to the output inverter 28 while providing galvanic isolation between the respective source 12, 14 or 16 and the load 30. Each input converter 24 receives an input having a respective input voltage on a respective path 32 and converts the input voltage to a common output voltage for transmission on a respective path 34. Advantageously, the input converter 24 operates over a wide input voltage range to accommodate the voltage ranges that may be provided by various input power sources. In one exemplary embodiment, an input voltage range of 2:1, or greater, is implemented. Accordingly, the input converter 24 in configured to operate over an input voltage range of at least 2:1, for example. As used herein, “adapted to,” “configured to,” and the like refer to elements that are sized, arranged or manufactured to form a specified structure or to achieve a specified result. Further, the input converter 24 may be adaptable such that the configuration for different voltage ranges can be easily accommodated, such as in the case of low voltage photovoltaic arrays, for instance. Each input converter 24 is galvanically isolated such that desirable grounding may be implemented. Galvanic isolation between the input source 12, 14 or 16 and the load may be achieved by implementing a high frequency input converter 24 having a small size and weight. Further, by isolating each input converter 24, the addition of other power sources to the system 10 is simplified, as can be appreciated by those skilled in the art.

As can be appreciated, a wide input voltage range can negatively influence the efficiency of the input converter 24. Further, the high starting voltage for the input converter 24 sourced by the photovoltaic array 12 may also reduce the efficiency of the input converter 24. To reduce the switching losses associated with the input converter 24, soft switching techniques may be implemented, as can be appreciated by those skilled in the art. Soft-switching techniques, as well as resonant techniques, may help to maintain high-efficiency in the input converter 24.

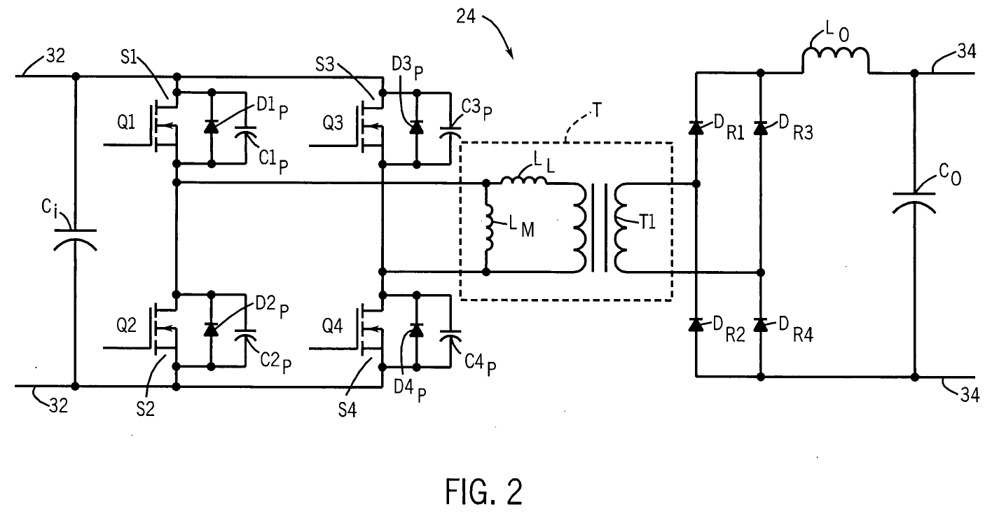

One advantageous exemplary embodiment of an input converter 24 that may be implemented in the present system 10 is illustrated in FIG. 2. As can be appreciated, FIG. 2 illustrates a low-loss switching (soft-switched) full-bridge converter driven by a dc voltage source (such as the photovoltaic array 12, battery source 14 or alternative source 16). The input capacitor Cᵢ is coupled between the positive and negative rails of the voltage source and serves as a high-frequency bypass capacitor. As can be appreciated, the negative rail may be electrically grounded. The input converter 24 includes four high-frequency switching devices, such as the switches S1-S4 which form a full-bridge at the input of the input converter 24. The switch S1 is coupled in series with the switch S2, and the switch S3 is coupled in series with the switch S4. The series combination of the switch S1 and the switch S2 is connected in parallel with the input capacitor Cᵢ. Similarly, the series combination of the switch S3 and the switch S4 is connected in parallel with the input capacitor Cᵢ.

The switch S1 comprises an ideal field effect transistor (FET) Q1 having a parasitic capacitor C1_{P} and a parasitic diode D1_{P}. Each of the parasitic capacitor C1_{P} and a parasitic diode D1_{P} are connected across the drain and source leads of the ideal FET Q1. The parasitic capacitor C1_{P} comprises the sum of the drain-gate capacitance and the drain-source capacitance of the ideal FET Q1, as can be appreciated by those skilled in the art. Similarly, the switches S2-S4 include respective parasitic capacitors C2_{P}-C4_{P} and parasitic diodes D2_{P}-D4_{P}. The parasitic capacitors C1_{P}-C4_{P} and the parasitic diodes D1_{P}-D4_{P} represent parasitic elements that exist internal to a practical power MOSFET., as can be appreciated by those skilled in the art.

The node connection between the switching devices S1 and S2 is connected to one end of the primary transformer T. The node connection between the switching devices S3 and S4 is connected to the other end of the primary transformer T. The transformer T comprises ideal transformer T₁, leakage inductor L_{L} and magnetizing inductor L_{M}. The output of the transformer T is connected through a rectifying bridge comprising diodes D_{R1}-D_{R4} to a low pass filter comprising an output inductor L_{O} and an output capacitor C_{O}.

Advantageously, the exemplary input converter 24 provides efficient soft switching at a constant operating frequency that can be achieved without the addition of auxiliary components. The parasitic elements of the FETs Q1-Q4 (i.e., C1_{P}-C4_{P}) are merely provided to illustrate the zero-voltage-switching (ZVS) action of the topology. Pulse width control of the output at a constant frequency is achieved by phase shifting one leg (e.g., Q1 and Q2) with respect to the other leg (e.g., Q3 and Q4). By proper design of the transformer leakage and magnetizing inductances (i.e., inductors L_{L} and L_{M}), the correct amount of energy is stored in the inductors during each high-frequency cycle such that when a power FET Q1-Q4 turns off, this inductive energy is interchanged with the parasitic (drain-source) capacitors C1_{P}-C4_{P} to soft switch the converter leg. Essentially, the capacitors C1_{P}-C4_{P} resonate with the transformer leakage inductance L_{L} and magnetizing inductance L_{M} when a FET Q1-Q4 turns off, which results in soft switching. This “transition resonance” occurs only during the switching intervals (rather than continuously as in load resonance converters), and therefore the additional circulating current associated with soft switching can be minimized. During the “off time” of the pulse width modulated (PWM) waveform, either two upper (e.g., Q1 and Q3) or two lower (Q2 and Q4) switches are conducting. This provides a path for current to circulate during this time. Advantageously, the transformer T may be small and light weight due to the higher switching frequency made possible by soft switching.

In an alternate embodiment of the input converter 24, the placement of a capacitor of correct size (not shown) in series with the transformer T may be implemented to interrupt the circulating current. In this embodiment, the series capacitor voltage rises to drive the circulating current to zero during the switching interval. The next switching event will be a zero-current switched (ZCS) type. As can be appreciated, ZCS is the complement of ZVS and results in zero device turn-off loss and small turn-on loss due to a small series inductance (rather than a parallel capacitor at turn-off for the ZVS case). Therefore with this alteration of the input converter 24, one leg will be switched in a ZCS mode while the other leg will remain in a ZVS mode. This has implications for higher power converters where the use of insulated gate bipolar transistors (IGBTs) is desired since ZCS operation of these devices may have certain advantages over ZVS operation, as can be appreciated by those skilled in the art.

Under heavy load conditions, the transformer leakage inductance L_{L} stores sufficient energy to maintain ZVS. Under light load conditions, however, little energy is stored in the leakage inductance L_{L}. For this case, energy can be stored in the transformer magnetizing inductance L_{M} to maintain ZVS. Thus, the transformer T may be designed to circulate some magnetizing current to maintain ZVS under light load conditions. Under intermediate load conditions, both the leakage and magnetizing inductances L_{L} and L_{M} supply energy. Because the circuit uses the transformer leakage inductance L_{L} as a circuit element, the primary and secondary windings of the transformer T are not necessarily tightly coupled. This allows the primary and secondary windings to be separated for good voltage isolation between primary and secondary windings, thereby leading to low capacitance for reduced common-mode electromagnetic interference (EMI). Further, this will also increase the isolation voltage that can be sustained across the transformer T. This feature, as well as the method by which the circuit switches, leads to inherently low EMI for this topology. Advantageously, the phase-shifted bridge is simple to control and current mode control can be effectively implemented.

Referring again to FIG. 1, an exemplary regulated dc-link 26 is illustrated. As can be appreciated, the dc-link 26 is illustrated as part of the photovoltaic converter 18, since the photovoltaic array 12 comprises the main power supply of the system 10. As can be appreciated, the dc-link 26 may be implemented in one of the other converters (battery converter 20 or alternative power source converter 22), rather than in the photovoltaic converter 18. Generally speaking, the dc-link 26 receives the converted voltages from each of the input converters 24 in the system 10 along the respective paths 34 and combines the paths in parallel to provide a single voltage to the output inverter 28 along a single path 36. In one exemplary embodiment, the dc-link 26 may comprise a bank of electrolytic capacitors, such as the dc link capacitor 38. The dc-link 26 also serves as the temporary energy storage for reactive power of the load 30. As can be appreciated, the various input converters 24 will regulate the dc-link voltage, thus, simplifying the requirements and design of the output inverter 28. A digital controller (not shown) may be implemented to keep the system control component count low. The digital controller may be coupled to the dc-link 26. In one embodiment of the present techniques, each input converter 24 independently controls a respective dc-link voltage, in accordance with the available power. The output inverter 28 would then draw as much power as possible and only throttle back if the dc-link voltage starts to drop below a predetermined threshold. Each of the input converters 24 would operate independently, and the only communication between the digital controller and the input converter 24 would be to for power up or power down of the respective input converter 24.

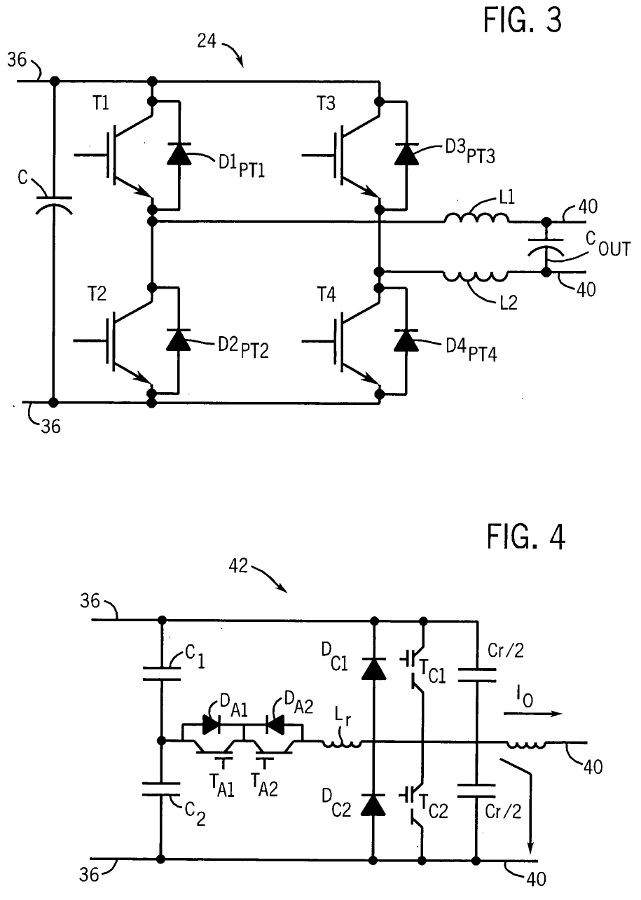

The output inverter 28 receives the combined de voltage from the regulated dc-link 26 along the path 36 and produces an ac voltage that can be supplied to a load 30 along the path 40, for use at an electrical outlet, for instance. The present exemplary output inverter 28 comprises a full-bridge hard switching circuit. FIG. 3 illustrates a schematic diagram of an exemplary output inverter 28 comprising switching devices T1-T4 configured to form a bridge. The switching devices T1-T4 may comprise insulated gate bipolar transistors (IGBTs) or power metal oxide semiconductor field effect transistors (MOSFETs), for example. Each switching device T1-T4 may have an associated parasitic diode D1_{PT1}-D4_{PT4}, as can be appreciated by those skilled in the art. As can be appreciated, the present exemplary embodiment of the output inverter 28 also includes a small, high-frequency dc capacitor C, coupled between the positive and negative voltage rails from the dc link 26 (i.e., paths 36) and placed very close to the four switching devices T1-T4, and thus helps reduce switching voltage spikes that would otherwise be present due to parasitic interconnect inductances. The de capacitor C may comprise a small film-type capacitor, an electrolytic capacitor, or both, depending on the source and the load on the circuit, as can be appreciated by those skilled in the art. The small film-type dc capacitor C is in addition to the dc link capacitor 38 in dc link 26. Alternatively, the additional dc capacitor C may be omitted. Further, the output inverter 28 may include a high-frequency output filter illustrated here as output inductors L1 and L2 and output capacitor Cₒᵤₜ, as can be appreciated by those skilled in the art.

The output inverter 28 is advantageously configured to run from a regulated dc voltage bus, which greatly simplifies the design, reduces device stresses and increases efficiency. That is to say that in the present exemplary embodiment, the dc bus voltage provided via path 36 is regulated by the input converter 24, as previously described. In this embodiment, the efficiency of the output inverter 28 is advantageously improved, because the output inverter 28 will not have to operate at low dc bus voltages that would result in higher currents and therefore higher device conduction losses. Disadvantageously, if the dc voltage is too low, clipping of the output ac voltage due to insufficient margin between the peak ac voltage and the low dc voltage may occur. In addition, a more favorable modulation index can be used to decrease device losses, as well as to maintain a good output waveform with minimal filtering, as can be appreciated by those skilled in the art.

While it may be advantageous to provide a hard switched output inverter 28, such as the output inverter 28 illustrated with respect to FIG. 3, to maintain simplicity and low cost, soft switched devices may also be implemented in the output inverter 28. Advantageously, soft switching the legs of the output inverter 28 may provide reduced switching losses, reduced EMI, and higher operating frequencies to reduce the size and cost of the output inverter 28. One alternate embodiment of the output inverter 28 implementing soft switching of inverter legs is the Auxiliary Resonant Commutated Pole (ARCP) inverter 42, illustrated with reference to FIG. 4. To avoid confusion, the ARCP inverter 42 has been given an alternate reference numeral (42). However, in the present exemplary embodiment of the system 10, one leg of the output inverter 28 may comprise the ARCP inverter 42, as described further below. As can be appreciated, the ARCP inverter 42 would be repeated for the second leg of the output inverter 28.

One phase leg (e.g., T1 and T2 of FIG. 3) of an ARCP circuit 42 is illustrated in FIG. 4. As can be appreciated, the regulated dc-link 26 provides a dc voltage to the ARCP circuit 42 via path 36. In the exemplary embodiment, the ARCP circuit 42 comprises a series combination of a resonant inductor Lᵣ and a pair of antiparallel-coupled auxiliary switching devices T_{A1} and T_{A2} coupled to the junction between a pair of upper and lower resonant capacitors Cr/2. The upper and lower resonant capacitors Cr/2 are coupled in series between the positive and negative (or ground) voltages supplied from the dc link 26 via the signal path 36. The auxiliary switching devices T_{A1} and T_{A2} each have a respective antiparallel diode D_{A1} and D_{A2} coupled thereacross. Further, the ARCP circuit 42 includes clamping switches T_{C1} and T_{C2}. Each clamping switch T_{C1} and T_{C2} is coupled in antiparallel with a respective clamping diodes D_{C1} and D_{C2}. As can be appreciated by those skilled in the art, the clamping switches T_{C1} and T_{C2} and their respective clamping diodes D_{C1} and D_{C2} provide respective mechanisms for clamping the quasi-resonant voltage V_{F} to the positive rail voltage during a resonant cycle and clamping the quasi-resonant voltage V_{F} to the negative rail voltage (or ground) during a resonant cycle via the signal path 40. The ARCP circuit 42 also includes first and second dc capacitors C₁ and C₂ that are coupled in series between the positive and negative rails of the dc voltage supplied from the regulated dc link 26. The first de capacitor C₁ is coupled to the positive rail and the second dc capacitor C₂ is coupled to the negative rail, for example.

To turn off one of the clamping switches T_{C1} or T_{C2}, a respective auxiliary switching device T_{A1} or T_{A2} is turned on and a resonant pulse of current flows through the small resonant inductor Lᵣ, such that the current in the clamping switches T_{C1} and T_{C2} is always in a direction to soft-switch the clamping switches T_{C1} and T_{C2}, as can be appreciated by those skilled in the art. Specifically, the clamping switches T_{C1} and T_{C2} are turned off with a resonant capacitor Cr/2 coupled in parallel (to reduce switching losses), and a switching device T_{A1} or T_{A2} does not have to turn on into a conducting clamping diode D_{C1} or D_{C2} (essentially eliminating IGBT turn-on losses and diode reverse recovery losses). As can be appreciated, the output current iₒ may be filtered to comprise an ac waveform supplying a load having rail voltages of +/−120 volts RMS ac, for example. Advantageously, this Zero-Voltage-Switching (ZVS) action greatly reduces switching losses and allows high-frequency operation of the output inverter 28 (implementing ARCP inverters 42) to generate high quality output waveforms with relatively small filters. Further, reliability of the output inverter 28 may be enhanced due to reduced stress on the main inverter power devices.

Referring again to FIG. 1, an optional battery charger 44 may be provided in the battery converter 20. The battery charger 44 may be sourced from the bus of the dc-link 26 (path 34) to allow a user the option of implementing an alternate battery charging system (not shown). Advantageously, the dc-link 26 may provide a desirable power source for the battery charger 44, because the dc-link 26 is always present in the system 10 and provides a regulated dc voltage. Accordingly, the design of the battery charger 44 may be simplified, which may reduce the cost of the battery charger 44, as can be appreciated by those skilled in the art. One embodiment of a converter for the battery charger 44 may be a flyback converter having a low component count and providing isolation. Diodes 46 and 48 may be implemented act as “ORing” or summing diodes so that multiple sources can supply power to the dc link 26. These diodes prevent the dc link capacitor 38 from discharging if the output of one of the input converters 24 is too low due to a circuit malfunction or lack of energy feeding the circuit (e.g., the battery discharges or the wind stops).

As can be appreciated, the presently described system 10 provides a system having advantageous grounding and isolation features. For instance, each of the input converters 24 of the system 10 is isolated with respect to one another. Advantageously, this allows grounding to be provided as per customer needs or code requirements. In special cases ground fault detection circuits (not shown) may be implemented to increase the safety aspect of the system 10, as can be appreciated. Further, implementing high-frequency transformer isolation allows the photovoltaic array 12 to be grounded in any desirable configuration. Present codes (e.g., the National Electrical Code) may require that one side of a two-wire photovoltaic system over 50 volts (125% of open-circuit photovoltaic-output voltage) be grounded, for example. However, as can be appreciated, specific code requirements may change over time and may vary depending on locality. Advantageously, the present system 10, implementing galvanic isolation, allows any grounding scheme to be used and will allow future code requirements to be met without changing the overall design.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A power conversion system comprising:
a first input converter configured to receive a first input voltage from a first power source and to produce a first converted input voltage;
a second input converter configured to receive a second input voltage from a second power source and to produce a second converted input voltage;
a combining circuit configured to receive each of the first converted input voltage and the second converted input voltage and to combine the first converted input voltage and the second converted input voltage to produce a combined converted voltage; and
an output inverter configured to receive the combined converted voltage and to produce an ac output voltage.

2. The power conversion system, as set forth in claim 1, wherein each of the first input converter and the second input converter comprises a high-frequency transformer driven by a soft-switched high-frequency converter.

3. The power conversion system, as set forth in claim 2, wherein the soft-switched high-frequency converter comprises a phase-shifted resonant bridge.

4. The power conversion system, as set forth in claim 1, wherein the output inverter comprises a soft-switched auxiliary resonant commutated pole inverter.

5. The power conversion system, as set forth in claim 1, wherein the output inverter is configured to produce an ac output voltage for a household mains voltage supply.

6. The power conversion system, as set forth in claim 1, wherein the output inverter is configured to produce an ac output voltage for supplying load voltages of +/−120 volts RMS.

7. The power conversion system, as set forth in claim 1, comprising a third input converter configured to receive a third input voltage from a third power source and to produce a third converted input voltage, wherein the combining circuit is configured to receive the third converted input voltage and combine the third converted input voltage with each of the first converted input voltage and the second converted input voltage to produce a combined converted voltage.

8. A power conversion system comprising:
a first conversion block comprising:
a first input converter configured to convert a first de power source voltage from a first voltage level to a second voltage level;
a dc link electrically coupled to the input converter and configured to receive the first dc power source voltage having the second voltage level from the first input converter and to include the first de power source voltage with a second de power source voltage having the second voltage level to produce a common de power voltage; and
an output inverter electrically coupled to the dc link and configured to convert the common dc power source voltage to an ac output power source voltage; and
a second conversion block electrically coupled to the dc link of the first conversion block and configured to convert the second dc power source voltage from a third voltage level to the second voltage level and configured to output the second dc power source voltage to the dc link for inclusion with the first dc power source voltage.

9. The power conversion system, as set forth in claim 8, wherein the first input converter comprises a high-frequency transformer driven by a soft-switched high-frequency converter.

10. The power conversion system, as set forth in claim 9, wherein the soft-switched high-frequency converter comprises a phase-shifted resonant bridge.

11. The power conversion system, as set fort in claim 8, wherein the second conversion block comprises a second input converter.

12. The power conversion system, as set forth in claim 11, wherein the second input converter comprises a high-frequency transformer driven by a soft-switched high-frequency converter.

13. The power conversion system, as set forth in claim 8, wherein the dc link comprises one or more electrolytic capacitors.

14. The power conversion system, as set forth in claim 8, wherein the output inverter comprises a soft-switched auxiliary resonant commutated pole inverter.

15. The power conversion system, as set forth in claim 8, wherein the output inverter is configured to convert the common dc power source voltage to an ac power source voltage and to provide the ac power source voltage to a household mains voltage supply.

16. The power conversion system, as set forth in claim 8, wherein the output inverter is configured to convert the common dc power source voltage to an ac power source voltage having rail voltages of +/−120 volts RMS.

17. The power conversion system, as set forth in claim 8, comprising a third conversion block electrically coupled to the dc link of the first conversion block and configured to convert a third dc power source voltage from a fourth voltage level to the second voltage level and configured to output the third dc power source voltage to the dc link for inclusion with each of the first dc power source voltage and the second dc power source voltage.

18. An integrated power source comprising:
a plurality of electrical power sources each configured to produce a respective dc voltage;
a plurality of input converters, wherein each of the plurality of input converters is electrically coupled to a respective one of the plurality of electrical power sources, and wherein each of the plurality of input converters is configured to receive a respective dc voltage and to convert the respective dc voltage to a common dc voltage level and to produce a respective output having the common voltage level;
a linking element coupled to each of the plurality of input converters and configured to combine each of the respective outputs to provide a combined dc voltage having the common voltage level; and
an output inverter coupled to the linking element and configured to receive the combined dc voltage and to convert the combined dc voltage to an ac output voltage.

19. The integrated power source, as set forth in claim 18, wherein one of the plurality of electrical power sources comprises a photovoltaic array.

20. The integrated power source, as set forth in claim 18, wherein one of the plurality of electrical power sources comprises a battery.

21. The integrated power source, as set forth in claim 18, wherein each of the plurality of input converters comprises a high-frequency transformer driven by a soft-switched high-frequency converter.

22. The integrated power source, as set forth in claim 21, wherein the soft-switched high-frequency converter comprises a phase-shifted resonant bridge.

23. The integrated power source, as set forth in claim 18, wherein the output inverter comprises a soft-switched auxiliary resonant commutated pole inverter.

24. The integrated power source, as set forth in claim 18, wherein the linking element comprises a plurality of electrolytic capacitors.

25. The integrated power source, as set forth in claim 18, wherein the output inverter is configured to receive the combined dc voltage and to convert the combined dc voltage to an ac output voltage for a household mains voltage supply.

26. The integrated power source, as set forth in claim 18, wherein the output inverter is configured to receive the combined dc voltage and to convert the combined dc voltage to an ac output voltage having rail voltages of +/−120 volts RMS.

27. A method of converting power from multiple sources comprising:
receiving a first voltage at a first input converter, the first voltage having a first voltage level;
receiving a second voltage at a second input converter, the second voltage having a second voltage level;
converting the first voltage level of the first voltage to a third voltage level;
converting the second voltage level of the second voltage to the third voltage level;
combining the first voltage having the third voltage level and the second voltage having the third voltage level to produce a third voltage having the third voltage level; and
converting the third voltage to an ac voltage having a fourth voltage level.

28. The method, as set forth in claim 27, wherein receiving the first voltage comprises receiving a first dc voltage from a first power source.

29. The method, as set forth in claim 27, wherein receiving the first voltage comprises receiving a first dc voltage from a photovoltaic array.

30. The method, as set forth in claim 28, wherein receiving the second voltage comprises receiving a second dc voltage from a second power source different from the first power source.

31. The method, as set forth in claim 30, wherein receiving the second source comprises receiving a second de voltage from a battery.

32. The method, as set forth in claim 27, comprising delivering the ac voltage having a fourth voltage level to a mains voltage supply.

33. The method, as set forth in claim 27, comprising delivering the ac voltage having a fourth voltage level to a mains voltage supply in a household.

34. The method, as set forth in claim 27, comprising:
receiving a fourth voltage at a third input converter, the fourth voltage having a fifth voltage level;
converting the fifth voltage level of the fourth voltage to the third voltage level; and
combining the fourth voltage having the third voltage level with each of the first voltage having the third voltage level and the second voltage having the third voltage level to produce the third voltage having the third voltage level.
